(19) United States
(12) Patent Application Publication
(10) Pub. No.: US 2017/0185587 A1
(43) Pub. Date: Jun. 29, 2017

(54) MACHINE TRANSLATION METHOD AND MACHINE TRANSLATION SYSTEM

(71) Applicant: Panasonic Intellectual Property Management Co., Ltd., Osaka (JP)

(72) Inventors: TETSUJI MOCHIDA, Osaka (JP); TSUTOMU HATA, Osaka (JP)

(21) Appl. No.: 15/371,258

(22) Filed: Dec. 7, 2016

(30) Foreign Application Priority Data
Dec. 25, 2015 (JP) 2015-253935
Jul. 25, 2016 (JP) 2016-145755

(51) Int. Cl. G06F 17/28; G10L 13/08; G10L 15/26

(52) U.S. Cl. CPC G06F 17/2836; G10L 15/26; G10L 13/08

(57) ABSTRACT

A machine translation method includes obtaining pre-translation text information generated by converting first speech data indicating an input speech sound uttered in a first language into text information, determining whether the pre-translation text information obtained in the obtaining includes first particular text information stored in a storage, and outputting, if it is determined in the determining that the pre-translation text information includes the first particular text information, at least either second particular text information or second speech data regarding the second particular text information associated with the first particular text information in the storage.

### BACKGROUND

1. Technical Field

The present disclosure relates to a machine translation method and a machine translation system.

2. Description of the Related Art

During these years, machine translation systems capable of translating speech sounds uttered in certain languages into other languages and outputting resulting speech sounds are gaining attention. Such machine translation systems are expected to facilitate global communication.

Such machine translation systems are also expanding their coverage from personal use to business use, and public facilities and commercial institutions are examining the use thereof as communication tools for visitors from abroad.

If such a machine translation system is introduced for business purposes, there are frequently translated words and sentences in each scene. In Japanese Unexamined Patent Application Publication No. 9-139969, for example, a technique is disclosed in which frequently translated words and sentences are associated with message codes and registered in advance. As a result, a user can call a sentence associated with a message code by specifying the message code.

### SUMMARY

With the technique disclosed in Japanese Unexamined Patent Application Publication No. 9-139969, however, it is difficult to reduce a burden on a speaker in terms of frequently translated words and sentences that vary between business scenes.

In order to reduce the burden on the speaker in terms of frequently translated words and sentences and reduce translation times of the words and the sentences, therefore, functions of a machine translation system need to be improved.

One non-limiting and exemplary embodiment provides a machine translation method and a machine translation system capable of improving the functions of the machine translation system.

In one general aspect, the techniques disclosed here feature a machine translation method used in a machine translation system. The machine translation method includes obtaining pre-translation text information generated by converting first speech data indicating an input speech sound uttered in a first language into text information, determining whether the pre-translation text information includes first particular text information, which indicates a particular word or sentence in the first language stored in a memory of the machine translation system, the memory storing the first particular text information and at least either second particular text information, which indicates a prepared fixed text that is a word or a sentence in the second language, which is different from the first language, and which does not have translation equivalence with the particular word or sentence, or second speech data regarding the second particular text information associated with the first particular text information, and outputting, if it is determined that the pre-translation text information includes the first particular text information, at least either the second particular text information or the second speech data regarding the second particular text information associated with the first particular text information in the memory.

With the machine translation method and the machine translation system in the present disclosure, the functions of the machine translation system can be improved.

It should be noted that general or specific embodiments may be implemented as a system, a method, an integrated circuit, a computer program, a computer-readable recording medium such as a compact disc read-only memory (CD-ROM), or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram illustrating an example of a functional configuration of a machine translation system in an example of the related art;

FIG. 2A is a diagram illustrating an outline of a service provided by an information management system in the present disclosure;

FIG. 2B is a diagram illustrating an example of a modified part of the information management system in the present disclosure;

FIG. 2C is a diagram illustrating another example of the modified part of the information management system in the present disclosure;

FIG. 3 is a block diagram illustrating an example of the configuration of a machine translation system according to a first embodiment;

FIG. 4 is a block diagram illustrating an example of the configuration of a translation determination processing unit illustrated in FIG. 3;

FIG. 5 is a block diagram illustrating another example of the configuration of the machine translation system according to the first embodiment;

FIG. 6 is a flowchart illustrating an outline of the operation of the machine translation system according to the first embodiment;

FIG. 7 is a flowchart illustrating a specific example of the operation of the machine translation system according to the first embodiment;

FIG. 8 is a diagram illustrating an example of particular sentences and fixed texts associated with each other in a storage section according to the first embodiment;

FIG. 9 is a diagram illustrating an example of a scene in which the machine translation system including a display is used;

FIG. 10 is a diagram illustrating an example of the configuration of a machine translation system according to a modification of the first embodiment;

FIG. 11 is a diagram illustrating an example of the configuration of an information terminal according to the modification of the first embodiment;

FIG. 12 is a sequence diagram illustrating the operation of the machine translation system according to the modification of the first embodiment;

FIG. 13 is a sequence diagram illustrating another example of the operation of the machine translation system according to the modification of the first embodiment;

FIG. 14 is a flowchart illustrating a specific example of the operation of a machine translation system according to a second embodiment;

FIG. 15 is a flowchart illustrating a specific example of the operation of a machine translation system according to a third embodiment;

FIG. 16 is a diagram illustrating an example of fixed texts associated with particular words and order of utterance in a storage section according to the third embodiment;

FIG. 17 is a diagram illustrating an outline of a service provided by an information management system according to a first type of cloud service (data center cloud service);

FIG. 18 is a diagram illustrating an outline of a service provided by an information management system according to a second type of cloud service (Infrastructure as a Service (IaaS) cloud service);

FIG. 19 is a diagram illustrating an outline of a service provided by an information management system according to a third type of cloud service (Platform as a Service (PaaS) cloud service); and

FIG. 20 is a diagram illustrating an outline of a service provided by an information management system according to a fourth type of cloud service (Software as a Service (PaaS) cloud service).

### DETAILED DESCRIPTION

### Underlying Knowledge Forming Basis of Present Disclosure

The advent of machine translation goes back to around 1990. The accuracy of machine translation at that time was about 60% in English-to-Japanese translation and about 50% in Japanese-to-English translation. That is, machine translation caused a large number of errors that need to be manually corrected, which made perfect machine translation a fancy dream. During these years, however, the accuracy of machine translation is greatly improving thanks to advanced machine learning techniques such as deep learning. Machine translation is now applied to personal computer (PC) applications, web applications, smartphone applications, and the like as a readily available translation system.

On the other hand, the accuracy of speech recognition is also improving as a result of development of various techniques based on statistical methods. Speech recognition is used not only for converting speech sounds uttered by users into texts but also for controlling devices through speech control interfaces that recognize speech sounds.

Machine translation systems that translate speech sounds uttered in certain languages into other languages and outputting resultant speech sounds are gaining attention as tools for facilitating global communication.

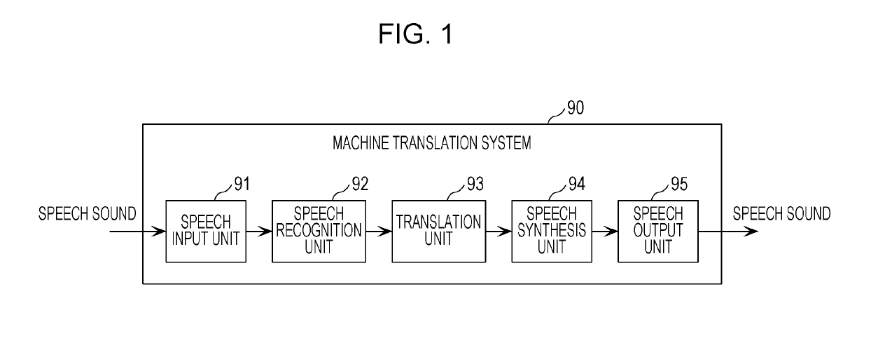

FIG. 1 is a diagram illustrating an example of a functional configuration of a machine translation system in an example of the related art. A machine translation system 90 illustrated in FIG. 1 includes a speech input unit 91, a speech recognition unit 92, a translation unit 93, a speech synthesis unit 94, and a speech output unit 95.

The speech input unit 91 receives a speech sound uttered by a speaker in a first language. The speech input unit 91 converts the received speech sound into speech data and outputs the speech data to the speech recognition unit 92. The speech recognition unit 92 performs a speech recognition process on the received speech data to convert the speech data into text data in the first language. The speech recognition unit 92 outputs the obtained text data in the first language to the translation unit 93. The translation unit 93 performs a translation process to translate the received text data in the first language into a second language and generate text data in the second language. The translation unit 93 outputs the generated text data in the second language to the speech synthesis unit 94. The speech synthesis unit 94 converts the received text data in the second language into speech data in the second language and outputs the speech data in the second language to the speech output unit 95. The speech output unit 95 outputs (utters) the received speech data in the second language as a speech sound in the second language.

The machine translation system 90 thus receives a speech sound uttered by a speaker in the first language and, after translating the speech sound into the second language, outputs a speech sound to a listener in the second language. As a result, persons whose languages are different from each other can communicate with each other.

Such machine translation systems have been personally used during traveling, on social networking service (SNS) websites, and the like. As speech recognition accuracy and translation accuracy improve, however, public facilities and commercial institutions are examining the use of machine translation systems as communication tools for visitors from abroad.

In order to introduce a machine translation system for business purposes, however, higher translation accuracy than in the case of personal use is required. On the other hand, when a machine translation system is used at a hotel, a travel agency, a transportation facility, an information office, a medical facility, or a shop, for example, the machine translation system needs to output particular words and sentences unique to each scene. Unless the machine translation system has learned the particular words and sentences in advance using a machine learning technique, for example, it might be difficult for the machine translation system to correctly recognize speech sounds and output translation results.

Furthermore, there are frequently translated words and sentences in each business scene. That is, a speaker (service provider) frequently speaks certain words and sentences to a person (service receiver) whose mother tongue is different from that of the speaker. In order to allow the machine translation system to translate such words and sentences for the person (service receiver), the speaker (service provider) needs to repeatedly speak the words and the sentences, which is troublesome to the speaker (service provider).

If such a word or a sentence is long, the burden on the speaker further increases, and the machine translation system might not be able to correctly recognize a speech sound and output a translation result at once. That is, if such a word or a sentence is long, the machine translation system undesirably receives a large amount of noise from a surrounding environment, which leads to an increase in the possibility of a recognition error in the speech recognition process performed on the word or the sentence and a resultant increase in the possibility of an incorrect translation result. In this case, the speaker needs to speak the word or the sentence again, which is troublesome to the speaker.

As an attempt to solve such a problem, in Japanese Unexamined Patent Application Publication No. 9-139969, for example, frequently translated words and sentences are associated with message codes and registered in advance in a message data reception apparatus that creates fixed messages.

More specifically, in Japanese Unexamined Patent Application Publication No. 9-139969, a correspondence table in which frequently used words and sentences are associated with message codes (No) is stored in a fixed message memory (33) in advance. If data received by a reception circuit (22) includes a message code, an item (a word or a sentence) corresponding to the message code included in the received data is extracted on the basis of the correspondence table stored in the fixed message memory (33). The message code included in the received data is then replaced by the extracted item to generate a message of a received signal. A speaker can thus call a word or a sentence associated with a certain message code by specifying the certain message code. As a result, a user can easily generate a long message using a message code, which reduces the burden on the user.

In the technique disclosed in Japanese Unexamined Patent Application Publication No. 9-139969, however, words and sentences registered to the correspondence table in advance are associated with meaningless numbers as message codes. The user, therefore, needs to learn correspondences between the words and the sentences and the values, which is troublesome. The burden on the user is especially large when the number of words and sentences registered in advance is large.

That is, in the technique disclosed in Japanese Unexamined Patent Application Publication No. 9-139969, a technical solution for reducing the burden on the speaker in terms of frequently translated words and sentences that vary between business scenes is not proposed.

In order to reduce the burden on the speaker in terms of frequently translated words and sentences and reduce translation times of the words and sentences, therefore, functions of a machine translation system need to be improved.

A machine translation method according to an aspect of the present disclosure is a machine translation method used in a machine translation system. The machine translation method includes obtaining pre-translation text information generated by converting first speech data indicating an input speech sound uttered in a first language into text information, determining whether the pre-translation text information includes first particular text information, which indicates a particular word or sentence in the first language stored in a memory of the machine translation system, the memory storing the first particular text information and at least either second particular text information, which indicates a prepared fixed text that is a word or a sentence in the second language, which is different from the first language, and which does not have translation equivalence with the particular word or sentence, or second speech data regarding the second particular text information associated with the first particular text information, and outputting, if it is determined that the pre-translation text information includes the first particular text information, at least either the second particular text information or the second speech data regarding the second particular text information associated with the first particular text information in the memory.

In this case, since the speaker can cause the machine translation system to output at least either the frequently used fixed text in the second language (second particular text information) or the speech data regarding the frequently used fixed text just by speaking the particular word or sentence in the first language (first particular text information), not by speaking all of a frequently used sentence in the first language, the burden on the speaker is reduced. In addition, the fixed text in the second language (second particular text information) and the speech data regarding the fixed text are associated with a simple word or the like in the first language expressing the fixed text in the second language. That is, the second particular text information and the speech data regarding the second particular text information are not associated with a meaningless number or the like. As a result, the user need not learn a large number of correspondences by heart in advance or separately.

In addition, for example, in the determining, it may be determined whether the pre-translation text information and the first particular text information stored in the memory match. If it is determined that the pre-translation text information and the first particular text information match, at least either the second particular information or the second speech data regarding the second particular text information associated with the first particular text information in the memory may be output in the outputting.

In this case, at least either the second particular text information or the speech data regarding the second particular text information is output only if a speech sound uttered by the speaker (pre-translation text information) and the first particular text information match.

That is, if the speaker speaks only the first particular text information, at least either the second particular text information or the speech data regarding the second particular text information is output as a translation result. On the other hand, if the speaker speaks a sentence including a word other than the first particular text information, a translation (translated text information) of the speech sound is output. As a result, the speaker can use the first particular text information as a word or a sentence included in a speech sound.

In addition, for example, in the memory, a piece of the second particular text information may be associated with two or more pieces of the first particular text information and order information indicating order in which the two or more pieces of the first particular text information should appear in a sentence. In the determining, it may be determined whether the pre-translation text information includes the two or more pieces of the first particular text information stored in the memory and whether the two or more pieces of the first particular text information appear in the order indicated by the order information. If it is determined that the pre-translation text information includes the two or more pieces of the first particular text information stored in the memory and that the two or more pieces of the first particular text information appear in the order indicated by the order information, at least either the piece of the second particular text information or the second speech data regarding the piece of the second particular text information associated with the two or more pieces of the first particular text information and the order information may be output in the outputting.

In this case, if a plurality of pieces of first particular text information appears in a speech sound uttered by the speaker (pre-translation text information) in certain order, at least either the second particular text information or speech data regarding the second particular text information associated with the plurality of pieces of first particular text information is output. That is, the speaker can determine whether to cause the machine translation system to output the second particular text information or the speech data regarding the second particular text information associated with a speech sound including the first particular text information or a translation of the speech sound uttered thereby by changing the order in which the first particular text information appears in the speech sound uttered thereby.

In addition, for example, in the memory, a piece of the second particular text information may be associated with one or more different pieces of the first particular text information indicating different particular sentences including a same particular word.

In this case, different words or sentences can be set to a piece of second particular text information. As a result, the user can cause the machine translation system 10 to output the second particular text information using one of the different words or sentences.

In addition, for example, if it is determined that the pre-translation text information does not include the first particular text information, translated text information, which is a translation of the pre-translation text information into the second language, may be output in the outputting.

In this case, if the pre-translation text information includes the first particular text information, a process for translating the pre-translation text information into the second language is omitted. If the pre-translation text information does not include the first particular text information, the process for translating the pre-translation text information into the second language is performed. As a result, a time taken to translate a frequently used word or sentence or a particular word or sentence can be reduced.

In addition, for example, if it is determined that the pre-translation text information includes the first particular text information stored in the memory, the translated text information need not be output in the outputting.

As described above, if the pre-translation text information includes the first particular text information, the process for translating the pre-translation text information into the second language is not performed. As a result, the translation process performed by the machine translation system can be simplified, and the capacity of the machine translation system can be used for another process, which improves the functions of the machine translation system.

In addition, for example, in the memory, third particular text information, which is a translation of the second particular text information into the first language, may be associated with the first particular text information and the second particular text information, or at least with the second particular text information. If at least either the second particular text information or the second speech data regarding the second particular text information is output in the outputting, the third particular text information may also be output.

As described above, when a fixed text in the second language, which is the second particular text information, is output, a sentence in the first language that is a translation of the fixed text in the second language is also output. As a result, the speaker can understand what kind of information is being output as a speech sound on the basis of a speech sound uttered thereby.

In addition, for example, the third particular text information output in the outputting may be displayed on a display.

In this case, the speaker can understand what kind of information is being output as a speech sound on the basis of a speech sound uttered thereby.

In addition, for example, the machine translation system may be connected, through a certain communicator, to an information terminal including a display. In the outputting, at least either the second particular text information or the second speech data regarding the second particular text information may be output to the information terminal through the certain communicator.

In addition, for example, if the second particular text information is output in the outputting, the information terminal may generate the second speech data by performing a speech synthesis process on the second particular text information and output a speech sound indicating the generated second speech data.

In addition, for example, the machine translation method may be used in a certain situation between a speaker of the first language and a speaker of the second language.

In addition, a machine translation system according to another aspect of the present disclosure includes a storage that stores first particular text information, which indicates a particular word or sentence in a first language and at least either second particular text information, which indicates a prepared fixed text that is a word or a sentence in a second language, which is different from the first language, and which does not have translation equivalence with the particular word or sentence, or second speech data regarding the second particular text information associated with the first particular text information, a processor, and a memory storing a computer program for causing the processor to perform operations including obtaining pre-translation text information generated by converting first speech data indicating an input speech sound uttered in the first language into text information, determining whether the pre-translation text information includes the first particular text information stored in the storage, and outputting, if the pre-translation text information includes the first particular text information, at least either the second particular text information or the second speech data regarding the second particular text information associated with the first particular text information in the storage.

It should be noted that these general or specific aspects may be implemented as a system, a method, an integrated circuit, a computer program, a computer-readable storage medium such as a CD-ROM, or any selective combination thereof.

A machine translation method according to an aspect of the present disclosure and the like will be specifically described hereinafter with reference to the drawings. Embodiments that will be described hereinafter are specific examples of the present disclosure. Values, shapes, components, steps, the order of the steps, and the like mentioned in the following embodiments are examples, and do not limit the present disclosure. Among the components descried in the following embodiments, ones not described in the independent claims, which define broadest concepts, will be described as arbitrary components. The embodiments may be combined with one another.

Outline of Service

First, an outline of a service that provides a machine translation system as an information management system according to an embodiment will be described.

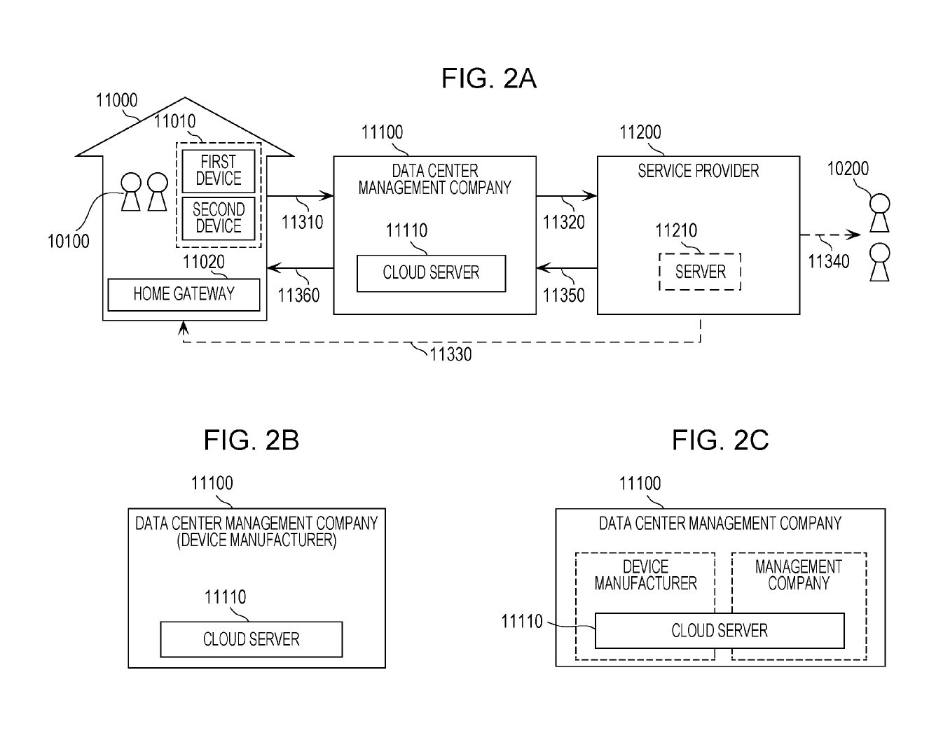

FIG. 2A is a diagram illustrating an outline of a service provided by the information management system in the present disclosure. FIG. 2B is a diagram illustrating an example of a modified part of the information management system in the present disclosure. FIG. 2C is a diagram illustrating another example of the modified part of the information management system in the present disclosure. The information management system illustrated in FIG. 2A includes a group 11000, a data center management company 11100, and a service provider 11200.

The group 11000 is a company, an organization, or a household, for example, of any magnitude. The group 11000 includes devices 11010 including a first device and a second device and a home gateway 11020. The devices 11010 include a device connectable to the Internet (e.g., a smartphone, a PC, or a television set) and a device that cannot connect to the Internet by itself (e.g., a light, a washing machine, or a refrigerator). The devices 11010 may include a device that cannot connect to the Internet by itself but connectable to the Internet through the home gateway 11020. Users 10100 use the devices 11010 in the group 11000.

The data center management company 11100 includes a cloud server 11110. The cloud server 11110 is a virtual server that cooperates with various devices through the Internet. The cloud server 11110 mainly manages big data, which is hard to handle with a common database management tool or the like. The data center management company 11100 manages a data center that manages data and the cloud server 11110. Details of the operation of the data center management company 11100 will be described later.

The data center management company 11100 is not limited to a company that manages only data and the cloud server 11110. As illustrated in FIG. 2B, when a device manufacturer that develops or manufactures one of the devices 11010 manages data or the cloud server 11110, for example, the device manufacturer is the data center management company 11100. In addition, the number of data center management companies 11100 is not limited to one. As illustrated in FIG. 2C, for example, when a device manufacturer and a management company jointly or separately manage data or the cloud server 11110, for example, the device manufacturer and/or the management company are data center management companies 11100.

The service provider 11200 includes a server 11210. The server 11210 may be of any magnitude, and, for example, may be a memory of a PC. In another case, the service provider 11200 might not include the server 11210.

The home gateway 11020 is not a mandatory component of the information management system. When the cloud server 11110 manages all data, for example, the home gateway 11020 is not necessary. In addition, there might be no device that cannot connect to the Internet by itself, such as in a case in which all devices in a household are connected to the Internet.

Next, transmission of information in the information management system will be described.

First, the first device and the second device in the group 11000 transmit log information to the cloud server 11110 of the data center management company 11100. The cloud server 11110 accumulates the log information regarding the first device and the second device (an arrow 11310 in FIG. 2A). The log information is, for example, information indicating operation states and operation times of the devices 11010. For example, the log information includes a television viewing history, recorder reservation information, washing machine operation times, the amount of laundry, refrigerator open/close times, and/or the number of times that the refrigerator has been opened and closed. The log information, however, is not limited to these examples, and may include various pieces of information obtained from various devices. The log information may be directly provided for the cloud server 11110 from the devices 11010 through the Internet. Alternatively, the log information may be temporarily accumulated in the home gateway 11020 from the devices 11010 and provided for the cloud server 11110 from the home gateway 11020.

Next, the cloud server 11110 of the data center management company 11100 provides the accumulated log information for the service provider 11200 in certain units. The certain units may be units in which the data center management company 11100 can sort out and provide the accumulated log information for the service provider 11200 or may be units requested by the service provider 11200. Alternatively, the certain units may vary depending on a situation. The log information is saved to the server 11210 owned by the service provider 11200 as necessary (an arrow 11320 in FIG. 2A).

The service provider 11200 then rearranges the log information as information suitable for a service provided for a user and provides the information for the user. The user for which the information is provided may be one of the users 10100 who use the devices 11010 or may be one of external users 10200. The service provider 11200 may directly provide information for one of the users 10100 and 10200 (arrows 11330 and 11340 in FIG. 2A). Alternatively, the service provider 11200 may provide the information for one of the users 10100 through the cloud server 11110 of the data center management company 11100 (arrows 11350 and 11360 in FIG. 2A). Alternatively, the cloud server 11110 of the data center management company 11100 may rearrange the log information as information suitable for a service provided for a user and provide the information for the service provider 11200.

The users 10100 may or may not be the same as the users 10200.

### First Embodiment

A machine translation system in the present disclosure will be described hereinafter.

### Configuration of Machine Translation System

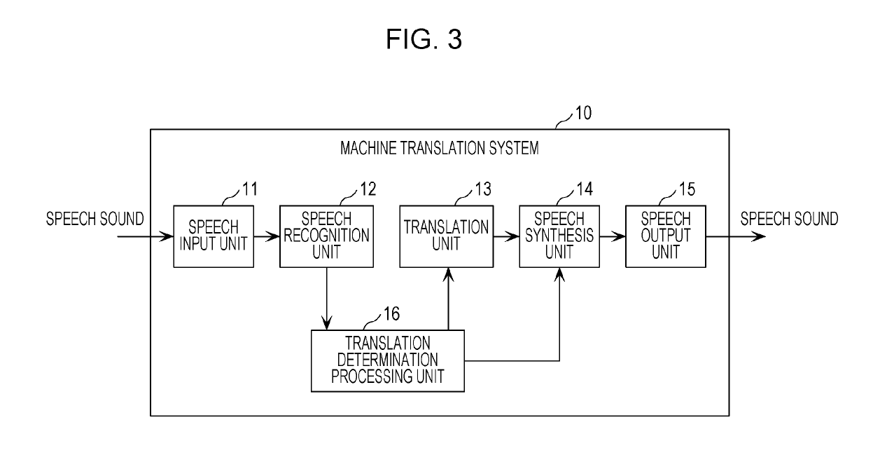

FIG. 3 is a block diagram illustrating an example of the configuration of a machine translation system 10 according to a first embodiment.

The machine translation system 10 is used in a certain situation between a speaker of the first language and a speaker of the second language. More specifically, as described above, the machine translation system 10 is used as a communication tool for a visitor from abroad a business situation (certain situation) such as a hotel, a travel agency, a transportation facility, an information office, a medical facility, or a shop. As illustrated in FIG. 3, the machine translation system 10 includes a speech input unit 11, a speech recognition unit 12, a translation unit 13, a speech synthesis unit 14, a speech output unit 15, and a translation determination processing unit 16. These components may be connected to one another by a large-scale integration (LSI) internal bus or the like.

### Speech Input Unit 11

The speech input unit 11 receives a speech sound uttered by a speaker in the first language. The speech input unit 11 converts the received speech sound into speech data (hereinafter referred to as “pre-translation speech data”) and outputs the pre-translation speech data to the speech recognition unit 12. In the present embodiment, the speech input unit 11 is, for example, a microphone.

### Speech Recognition Unit 12

The speech recognition unit 12 performs a speech recognition process on obtained pre-translation speech data to convert the pre-translation speech data into text information in the first language (hereinafter referred to as “pre-translation text information”). The speech recognition unit 12 outputs the pre-translation text information to the translation determination processing unit 16.

The speech recognition unit 12 may be a computer including a central processing unit (CPU) and a memory and perform the speech recognition process, but is not limited to this. The speech recognition unit 12 may have a communication function and a memory function and communicate with cloud servers through certain communication means such as the Internet. In this case, the speech recognition unit 12 may transmit the obtained pre-translation speech data to a cloud serer and obtain a result of the speech recognition process performed on the pre-translation speech data from the cloud server.

### Translation Unit 13

The translation unit 13 obtains pre-translation text information from the translation determination processing unit 16 and performs a translation process, by which text information in the first language is translated into text information in the second language, on the obtained pre-translation text information to generate text information in the second language (hereinafter referred to as “post-translation text information”). The translation unit 13 outputs the generated post-translation text information to the speech synthesis unit 14.

Although the translation unit 13 outputs the generated post-translation text information to the speech synthesis unit 14 here, the operation performed by the translation unit 13 is not limited to this. The translation unit 13 may output the generated post-translation text information to the translation determination processing unit 16, and the translation determination processing unit 16 may output the post-translation text information to the speech synthesis unit 14, instead. That is, the translation unit 13 may output the generated post-translation text information to the speech synthesis unit 14 through the translation determination processing unit 16.

The translation unit 13 may be a computer including a CPU and a memory and perform the translation process, but is not limited to this. The translation unit 13 may have a communication function and a memory function and communicate with a cloud server through the certain communication means such as the Internet.

In this case, the translation unit 13 may transmit the obtained pre-translation text information to a cloud server and obtain a result of the translation process performed on the pre-translation text information from the cloud server.

### Speech Synthesis Unit 14

The speech synthesis unit 14 obtains post-translation text information and performs a speech synthesis process on the post-translation text information to generate speech data in the second language (hereinafter referred to as “post-translation speech data”). If obtaining the second particular text information, the speech synthesis unit 14 performs the speech synthesis process on the second particular text information to generate speech data in the second language (hereinafter referred to as “post-translation speech data”). The speech synthesis unit 14 then outputs the generated post-translation speech data to the speech output unit 15.

The speech synthesis unit 14 may be a computer including a CPU and a memory and perform the speech synthesis process, but is not limited to this. The speech synthesis unit 14 may have a communication function and a memory function and transmit the obtained post-translation text information or second particular text information to a cloud server through the certain communication means such as the Internet. The speech synthesis unit 14 may then obtain a result of the speech recognition process performed on the transmitted post-translation text information or second particular text information from the cloud server.

### Speech Output Unit 15

The speech output unit 15 performs a speech output process by which received speech data in the second language is output (uttered) in the second language as a speech sound. In the present embodiment, the speech output unit 15 is a speaker or the like.

### Translation Determination Processing Unit 16

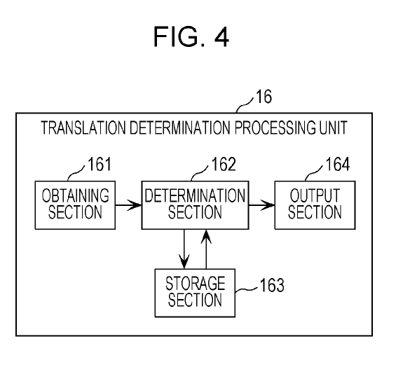

FIG. 4 is a block diagram illustrating an example of the configuration of the translation determination processing unit 16 illustrated in FIG. 3.

As illustrated in FIG. 4, for example, the translation determination processing unit 16 includes an obtaining section 161, a determination section 162, a storage section 163, and an output section 164.

The storage section 163 stores first particular text information, which indicates a particular word or sentence in the first language, and second particular text information, which indicates a prepared fixed text such as a word or a sentence in the second language, which is different from the first language, and which does not have translation equivalence with the particular word or sentence, associated with each other. The first particular text information is, for example, a short sentence (particular sentence), such as “explain cigarettes” or “explain the translation device”, including a keyword (particular word), such as “cigarettes” or “translation device”, but may be the keyword (particular word) itself. When there is no translation equivalence, translation is not symmetrical. That is, when there is no translation equivalence, a particular sentence in the first language such as “explain the translation device” corresponds to a fixed text in the second language such as “Welcome. This is a translation device. Please speak a short sentence in English after the beep. It will be translated into Japanese”, not a direct translation of the particular sentence or a translation of a text including the particular sentence.

Alternatively, the storage section 163 may store a piece of second particular text information and one or more pieces of first particular text information that indicate different particular sentences including the same particular word associated with each other. That is, a piece of second particular text information may be associated with a plurality of different sentences or keywords. In this case, the piece of second particular text information, which is a fixed text, can be retrieved with one of the plurality of different sentences or words.

The obtaining section 161 obtains pre-translation text information generated by converting first speech data, which indicates an input speech sound uttered in the first language, into text information.

The determination section 162 determines whether the pre-translation text information obtained by the obtaining section 161 includes the first particular text information stored in the storage section 163.

If determining that the pre-translation text information includes the first particular text information, the determination section 162 causes the output section 164 to output the second particular text information associated with the first particular text information in the storage section 163. If determining that the pre-translation text information includes the first particular text information stored in the storage section 163, the determination section 162 does not cause the output section 164 to output the pre-translation text information obtained by the obtaining section 161.

If determining that the pre-translation text information does not include the first particular text information, the determination section 162 causes the output section 164 to output the pre-translation text information.

The output section 164 outputs the second particular text information or the pre-translation text information in accordance with a result of the determination made by the determination section 162. In the present embodiment, the output section 164 outputs the second particular text information to the speech synthesis unit 14 or the pre-translation text information to the translation unit 13 in accordance with the result of the determination made by the determination section 162.

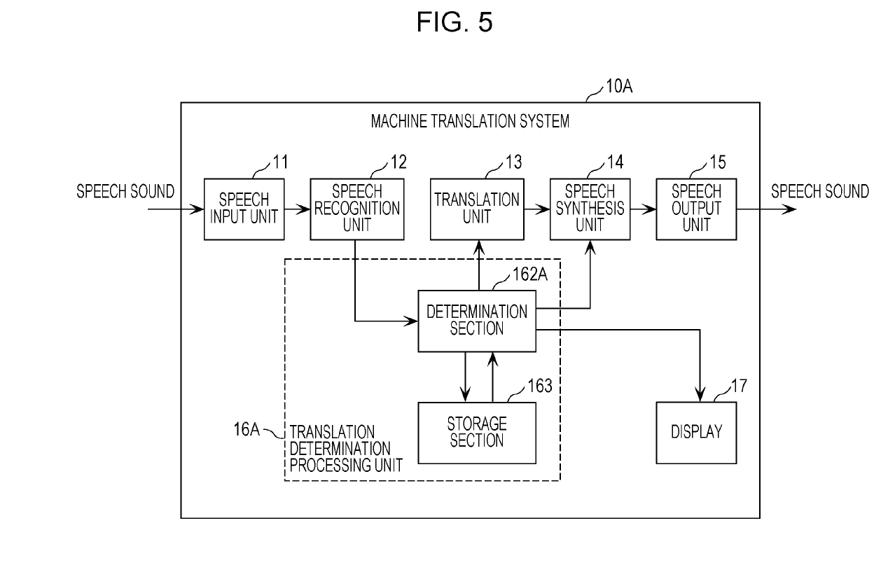

The translation determination processing unit 16 is not limited to the example illustrated in FIG. 4. Another example will be described hereinafter with reference to FIG. 5. FIG. 5 is a block diagram illustrating an example of the configuration of a machine translation system 10A according to the first embodiment. The same components as those illustrated in FIG. 3 or 4 are given the same reference numerals, and detailed description thereof is omitted.

The machine translation system 10A illustrated in FIG. 5 is different from the machine translation system 10 illustrated in FIG. 3 in terms of the configuration of a translation determination processing unit 16A. Differences between the translation determination processing unit 16A and the translation determination processing unit 16 illustrated in FIG. 4 are omission of the obtaining section 161 and the output section 164 and addition of a display 17 in the translation determination processing unit 16A and the configuration of a determination section 162A.

The determination section 162A has the functions of the obtaining section 161 and the output section 164 as well as all the functions of the determination section 162. That is, the determination section 162A obtains pre-translation text information output from the speech recognition unit 12 and determines whether the obtained pre-translation text information includes the first particular text information stored in the storage section 163. If the obtained pre-translation text information does not include the first particular text information, the determination section 162A outputs the pre-translation text information to the translation unit 13.

On the other hand, if the obtained pre-translation text information includes the first particular text information stored in the storage section 163, the determination section 162A does not output the pre-translation text information to the translation unit 13. The determination section 162A extracts, from the storage section 163, the second particular text information associated with the first particular text information determined to be included in the pre-translation text information and outputs the second particular text information to the speech synthesis unit 14.

The display 17 may, for example, display the second particular text information output to the speech synthesis unit 14.

The storage section 163 may also store third particular text information, which is a translation of the second particular text information into the first language, associated with the first particular text information and the second particular text information, or at least with the second particular text information.

In this case, the determination section 162A may output third particular text information associated with the first particular text information determined to be included in the pre-translation text information or the extracted second particular text information to the display 17 to display the third particular text information on the display 17. Furthermore, speech data in the first language generated from the third particular text information associated with the second particular text information may be separately output before or after speech data in the second language generated from the second particular text information is output.

As a result, a speaker can visually or aurally understand what kind of information is being given to a listener on the basis of a speech sound uttered thereby.

### Operation of Machine Translation System 10

An outline of the operation of the machine translation system 10 configured as above will be described.

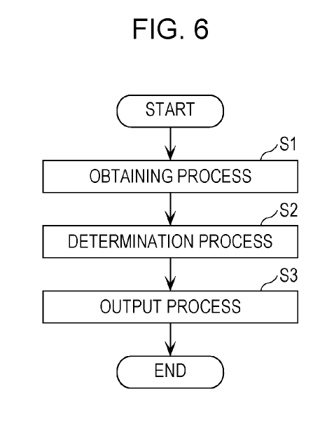

FIG. 6 is a flowchart illustrating the outline of the operation of the machine translation system 10 according to the first embodiment.

First, the machine translation system 10 performs a process for obtaining pre-translation text information generated by converting first speech data, which indicates an input speech sound uttered in the first language, into text information (51)

Next, the machine translation system 10 performs a process for determining whether the pre-translation text information obtained in S1 includes the first particular text information stored in the storage section 163 (S2).

Next, if determining in S2 that the pre-translation text information includes the first particular text information, the machine translation system 10 performs a process for outputting the second particular text information associated with the first particular text information in the storage section 163 (S3).

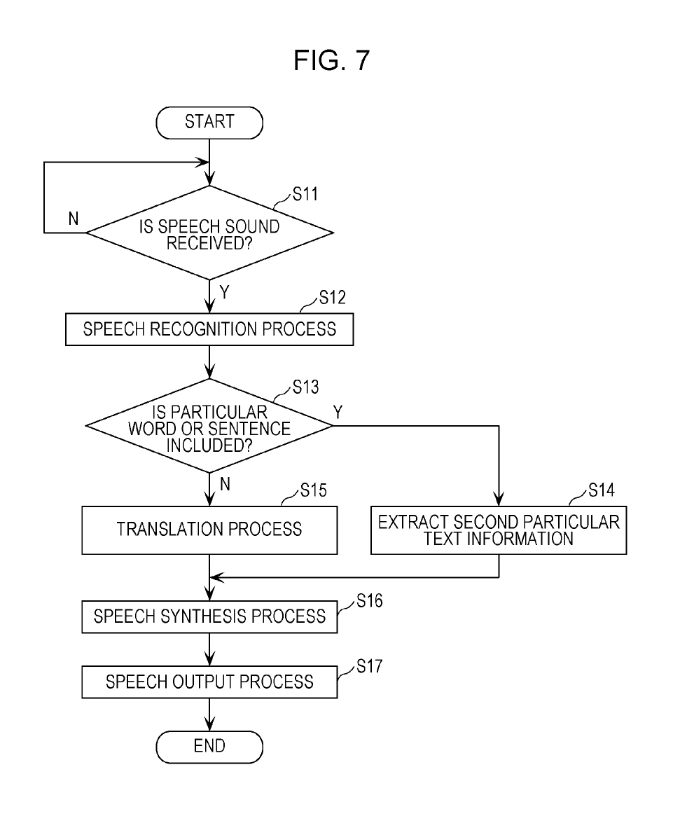

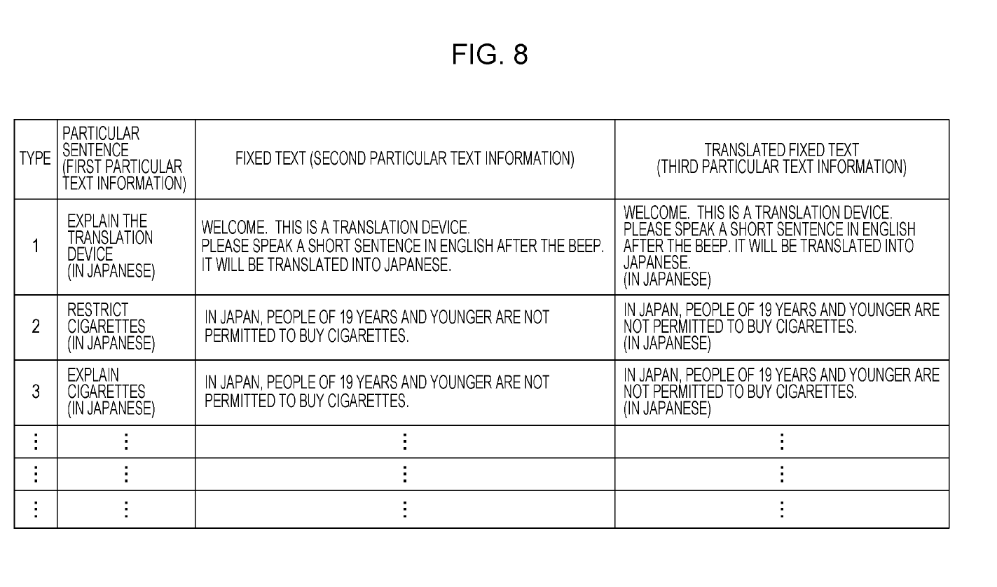

Next, a specific example of the operation of the machine translation system 10 will be described with reference to FIGS. 7 and 8.

FIG. 7 is a flowchart illustrating the specific example of the operation of the machine translation system 10 according to the first embodiment.

As illustrated in FIG. 7, first, if the machine translation system 10 recognizes a speech sound uttered by a speaker, that is, if the speech input unit 11 receives a speech sound uttered by the speaker (Y in S11), the machine translation system 10 converts the speech sound input to the speech input unit 11 into pre-translation speech data and outputs the pre-translation speech data to the speech recognition unit 12.

Next, the speech recognition unit 12 performs the speech recognition process on the obtained pre-translation speech data to convert the pre-translation speech data into pre-translation text information in the first language (S12). The speech recognition unit 12 outputs the obtained pre-translation text information to the translation determination processing unit 16.

Next, the translation determination processing unit 16 performs the determination process. That is, the translation determination processing unit 16 determines whether the obtained pre-translation text information includes a particular word or sentence registered to the storage section 163 in advance (S13).

If determining in S13 that the pre-translation text information includes a particular word or sentence (Y in S13), the translation determination processing unit 16 extracts the second particular text information associated with the first particular text information in the storage section 163 (S14). The translation determination processing unit 16 outputs the extracted second particular text information to the speech synthesis unit 14. The translation determination processing unit 16 may output the third particular text information associated with the extracted second particular information to a display of the machine translation system 10, instead.

On the other hand, if determining in S13 that the pre-translation text information does not include a particular word or sentence (N in S13), the translation determination processing unit 16 outputs the pre-translation text information to the translation unit 13. The translation unit 13 performs the translation process to translate the obtained pre-translation text information into the second language to generate post-translation text information (S15). The translation unit 13 outputs the generated post-translation text information to the speech synthesis unit 14.

Next, the speech synthesis unit 14 performs the speech synthesis process to generate post-translation speech data in the second language from the obtained second particular text information or post-translation text information (S16). The speech synthesis unit 14 outputs the generated post-translation speech data to the speech output unit 15.

Next, the speech output unit 15 performs the speech output process to output (utter) the obtained post-translation speech data in the second language as a speech sound (S17).

FIG. 8 is a diagram illustrating an example of particular sentences and fixed texts associated with each other in the storage section 163 according to the first embodiment.

In FIG. 8, Japanese particular sentences are indicated as examples of the first particular text information, and English fixed texts are indicated as examples of the second particular text information. Translated fixed texts, which are Japanese translations of the English fixed texts, are indicated as examples of the third particular text information.

If a speaker says, “I will explain the translation device”, to the machine translation system 10 in Japanese, for example, the machine translation system 10 converts speech data regarding the speech sound uttered by the speaker into Japanese pre-translation text information through the speech recognition process. Next, the translation determination processing unit 16 of the machine translation system 10 performs the determination process to determine that the pre-translation text information includes a particular sentence “explain the translation device” stored in the storage section 163. In this case, the machine translation system 10 does not perform the translation process to translate the Japanese sentence, “I will explain the translation device”, uttered by the speaker into English. Instead, the machine translation system 10 extracts, as the second particular text information, an English fixed text, “Welcome. This is a translation device. Please speak a short sentence in English after the beep. It will be translated into Japanese”, which corresponds to the particular sentence “explain the translation device” and is stored in the storage section 163. The machine translation system 10 then performs the speech synthesis process and the speech output process to output a speech sound indicating the English fixed text.

Now, an example of a case in which the speaker utters a speech sound different from above using a word “translation device” and the machine translation system 10 performs the translation process will be described. If the speaker says, “You can buy the translation device over there”, to the machine translation system 10 in Japanese, for example, the machine translation system 10 converts speech data regarding the speech sound uttered by the speaker into Japanese pre-translation text information. Next, the translation determination processing unit 16 of the machine translation system 10 performs the determination process to determine that the pre-translation text information does not include a particular sentence stored in the storage section 163. In this case, the machine translation system 10 performs the translation process to translate the Japanese sentence, “You can buy the translation device over there”, uttered by the speaker in Japanese into English. The machine translation system 10 then performs the speech synthesis process and the speech output process to output a speech sound indicating the English sentence.

The same holds when the speaker speaks a sentence including a word “cigarettes” to the machine translation system 10, and description of this case is omitted.

In FIG. 8, however, the same fixed text is associated with different particular sentences including the same word “cigarettes”, namely “restrict cigarettes” and “explain cigarettes”, in the storage section 163. A plurality of different particular sentences (first particular text information) may thus be associated with the same fixed text (second particular text information). In addition, a plurality of different particular words (first particular text information) may be associated with the same fixed text (second particular text information). In this case, a user can output the second particular text information using one of the plurality of different particular sentences or words.

As described above, the machine translation system 10 may further include a display. In this case, when the machine translation system 10 performs the determination process and outputs an English fixed text associated with a particular sentence in the storage section 163 to a listener whose mother tongue is English, the machine translation system 10 displays a translated fixed text (third particular text information) corresponding to the fixed text to a speaker whose mother tongue is Japanese. As a result, when a speech sound indicating a fixed text in the second language (second particular text information) different from but associated with a particular sentence in the first language uttered by a speaker, the speaker can understand what kind of fixed text is being output as a speech sound. In addition, even if the speaker has not learned fixed texts by heart, the speaker can understand what kind of fixed text is being output in the second language as a speech sound by taking a look at a translated fixed text (fixed text in the first language). The speaker, therefore, can smoothly talk with the listener.

### Advantageous Effects

As described above, according to the first embodiment, a speaker (utterer) can cause the machine translation system 10 to output a frequently used fixed text in the second language (second particular text information) unique to each scene, such as a word or a sentence, just by uttering a speech sound including a particular word or sentence (first particular text information) to the machine translation system 10 in the first language. As a result, the burden on the speaker is reduced.

In addition, a fixed text in the second language (second particular text information) is associated with a simple word or the like in the first language indicating the fixed text in the second language. That is, the second particular text information according to the first embodiment is not associated with a meaningless number or the like. As a result, the user need not learn correspondences between numbers and the second particular text information in advance or separately.

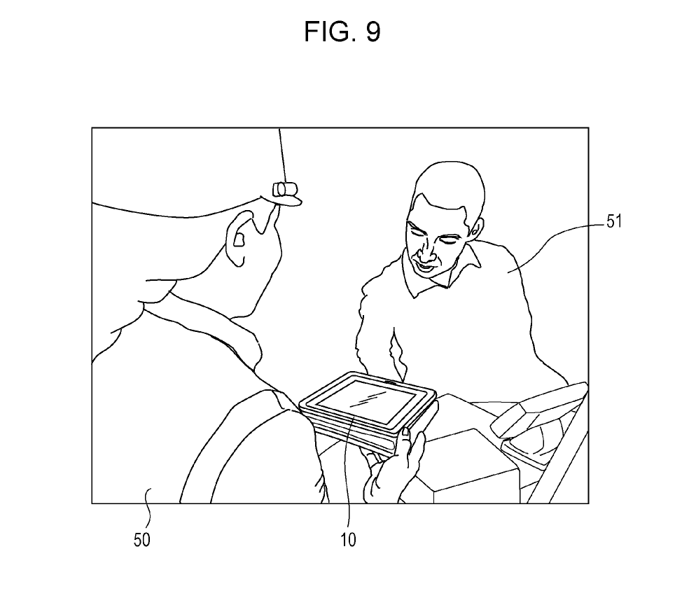

In addition, as described above, the machine translation system 10 according to the first embodiment may further include a display. FIG. 9 is a diagram illustrating an example of a scene (use case) in which the machine translation system 10 including a display is used. A speaker 50 speaks the first language and corresponds to a service provider. A listener 51 speaks the second language and corresponds to a service receiver. FIG. 9 illustrates a scene in which the speaker 50 and the listener 51 use a plurality of languages for business purposes.

In this case, when the machine translation system 10 performs the determination process and outputs a speech sound indicating the second particular text information corresponding to the first particular text information for the listener 51, whose mother tongue is the second language, the machine translation system 10 may display the third particular text information, which is a translation of the second particular text information into the first language, on the display. As a result, the speaker 50 can understand what kind of second particular text information is being output. Even if the speaker 50 has not learned the second particular text information by heart, the speaker 50 can understand the second particular text information by taking a look at the third particular text information, which is a translation of the second particular text information into the first language. As a result, the speaker 50 can smoothly talk with the listener 51.

Although a speaker utters a speech sound in the first language to the machine translation system 10 and the machine translation system 10 outputs a speech sound in the second language in the first embodiment, the configuration employed is not limited to this. A speech sound uttered by the speaker in the first language may be input to an information terminal connected to the machine translation system 10 through certain communication means, and the information terminal may output a speech sound in the second language.

### Modification

The components of the machine translation system 10 illustrated in FIG. 3 may be shared by an information terminal and servers. This case will be described hereinafter as a modification.

### Configuration of Machine Translation System 10B

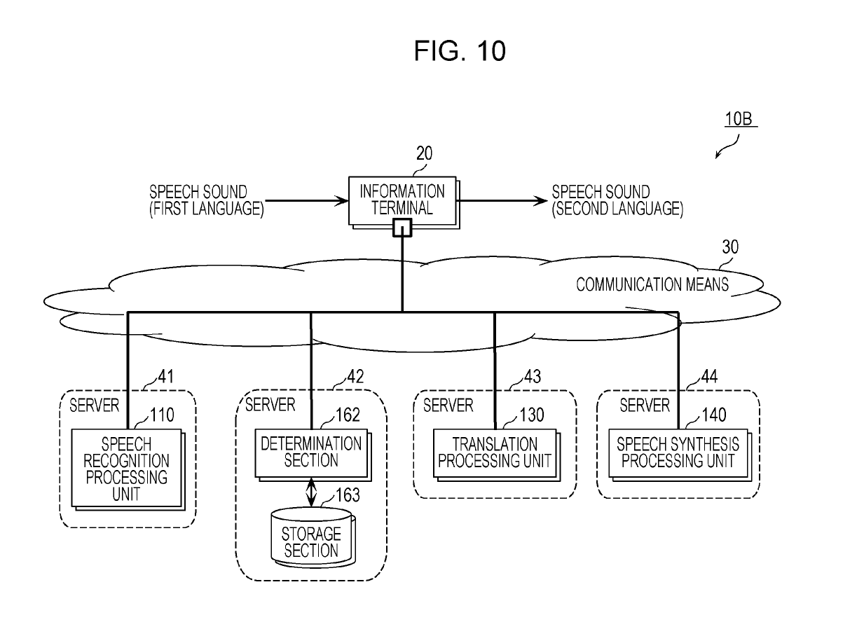

FIG. 10 is a diagram illustrating an example of the configuration of a machine translation system 10B according to a modification of the first embodiment. In the machine translation system 10B, the second particular text information is output to an information terminal 20 including a display through certain communication means 30. As illustrated in FIG. 10, the machine translation system 10A includes the information terminal 20 and servers 41 to 44. The information terminal 20 and the servers 41 to 44 are connected to one another through the communication means 30.

### Communication Means 30

The communication means 30 is, for example, a wired or wireless network connected to the Internet through an optical line, asymmetric digital subscriber line (ADSL), or the like. In this case, the information terminal 20 may be a dedicated terminal, and the servers 41 to 44 may be cloud servers.

Alternatively, the communication means 30 may be a mobile phone network achieved by a third generation (3G), a fourth generation (4G), or a fifth generation (5G) of wireless mobile telecommunications technology. In this case, the information terminal 20 may be a dedicated terminal, and the severs 41 to 44 may be cloud servers.

Alternatively, the communication means 30 may be a near-field communication technology such as Bluetooth (registered trademark), ibeacon (registered trademark), Infrared Data Association (IrDA; registered trademark), Wi-Fi (registered trademark), TransferJet (registered trademark), or specified low-power radio. In this case, the information terminal 20 may be a terminal, and the servers 41 to 44 may be dedicated local servers or on-premises servers.

Alternatively, the communication means 30 may be a 1-to-N dedicated network. In this case, the information terminal 20 may be a terminal, and the servers 41 to 44 may be dedicated local servers or on-premises servers.

Alternatively, the communication means 30 may be a high-speed wireless network such as a data communication module (DCM). In this case, the information terminal 20 may be a vehicle terminal, and the servers 41 to 44 may be cloud servers.

### Information Terminal 20

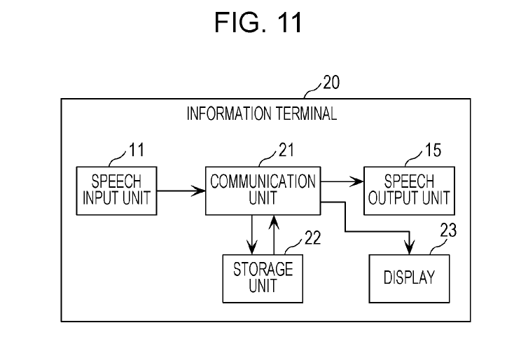

FIG. 11 is a diagram illustrating an example of the configuration of the information terminal 20 according to the modification of the first embodiment. The same components as those illustrated in FIG. 3 are given the same reference numerals, and detailed description thereof is omitted.

The information terminal 20 receives a speech sound uttered by a speaker in the first language and outputs, to a listener, a speech sound indicating a translation, into the second language, of the second particular text information based on a text indicated by the received speech sound or the text. The information terminal 20 thus plays a role of a user interface in the machine translation system 10B.

As illustrated in FIG. 11, the information terminal 20 includes the speech input unit 11, the speech output unit 15, a communication unit 21, a storage unit 22, and a display 23. The display 23 is not a mandatory component. The communication unit 21 is achieved by a computer including a CPU and a memory and communicates data with the servers 41 to 44 through the communication means 30. The storage unit 22 stores data obtained by the communication unit 21 from the servers 41 to 44 and data to be output by the communication unit 21. If the communication unit 21 obtains the second particular text information or the third particular text information, for example, the display 23 displays the second particular text information or the third particular text information.

In the present modification, if receiving a speech sound uttered by the speaker in the first language, the information terminal 20 converts the received speech sound into pre-translation speech data and transmits the pre-translation speech data to the server 41 through the communication means 30. The information terminal 20 receives, from the server 41, pre-translation text information in the first language obtained through the speech recognition process.

The information terminal 20 transmits the pre-translation text information received from the server 41 to the server 42. The information terminal 20 then receives the second particular text information or the pre-translation text information from the server 42.

If receiving the pre-translation text information from the server 42, the information terminal 20 transmits the pre-translation text information to the server 43. The information terminal 20 then receives the post-translation text information from the server 43. Alternatively, the server 41 may directly transmit the pre-translation text information to the server 42 without using the information terminal 20.

If receiving the second particular text information from the server 42, the information terminal 20 transmits the second particular text information to the server 44. After receiving the post-translation text information from the server 43, the information terminal 20 transmits the post-translation text information to the server 44. Alternatively, the server 42 may directly transmit the second particular text information to the server 44 without using the information terminal 20. The information terminal 20 then receives post-translation speech data regarding the second particular text information or the pre-translation text information from the server 44.

After receiving the post-translation speech data regarding the second particular text information or the pre-translation text information, the information terminal 20 causes the speech output unit 15 to output a speech sound.

The information terminal 20 may further include a speech synthesis processing unit 140. In this case, if receiving the second particular text information from the server 42, the information terminal 20 may perform the speech synthesis process on the second particular text information to generate the second speech data and output a speech sound indicating the generated second speech data.

### Servers 41 to 44

The server 41 includes a communication unit, which is not illustrated, and a speech recognition processing unit 110. The server 41 performs, using the speech recognition processing unit 110, the speech recognition process on pre-translation speech data transmitted from the information terminal 20 to convert the pre-translation speech data into pre-translation text information in the first language. The server 41 then transmits the pre-translation text information in the first language to the information terminal 20.

Alternatively, the server 41 may directly transmit the pre-translation text information to the server 42 without using the information terminal 20.

The server 42 includes a communication unit and a translation determination processing unit 16A, which are not illustrated, that is, the communication unit, which is not illustrated, the determination section 162, and the storage section 163. The determination section 162 and the storage section 163 have already been described, and detailed description thereof is omitted.

If the determination section 162 determines that the pre-translation text information transmitted from the information terminal 20 includes the first particular text information, the server 42 transmits the second particular text information associated with the first particular text information in the storage section 163 to the information terminal 20. On the other hand, if the determination section 162 determines that the pre-translation text information does not include the first particular text information, the server 42 transmits the pre-translation text information to the information terminal 20.

Alternatively, the server 42 may directly transmit the second particular text information to the server 44 or the pre-translation text information to the server 43 without using the information terminal 20.

The server 43 includes a communication unit, which is not illustrated, and a translation processing unit 130. The server 43 performs, using the translation processing unit 130, a process for translating the pre-translation text information transmitted from the information terminal 20 into the second language to generate post-translation text information in the second language. The server 43 transmits the generated post-translation text information to the information terminal 20.

Alternatively, the server 43 may directly transmit the post-translation text information to the server 44 without using the information terminal 20.

The server 44 includes a communication unit, which is not illustrated, and the speech synthesis processing unit 140. After the post-translation text information is transmitted from the information terminal 20, the server 43 causes the speech synthesis processing unit 140 to perform the speech synthesis process to generate post-translation speech data in the second language from the post-translation text information. If the second particular text information is transmitted from the information terminal 20, the server 43 causes the speech synthesis processing unit 140 to perform the speech synthesis process to generate the post-translation speech data in the second language from the second particular text information. The server 43 then transmits the generated post-translation speech data regarding the second particular text information or the post-translation text information to the information terminal 20.

Although an example in which the components of the machine translation system 10 are shared by the information terminal 20 and the servers 41 to 44 is illustrated in FIG. 10, the components of the machine translation system 10 may be shared in a different manner. For example, the components of the machine translation system 10 may be shared by servers fewer than the number of servers illustrated in FIG. 10, or may be integrated in a single server, instead.

### Operation of Machine Translation System 10B

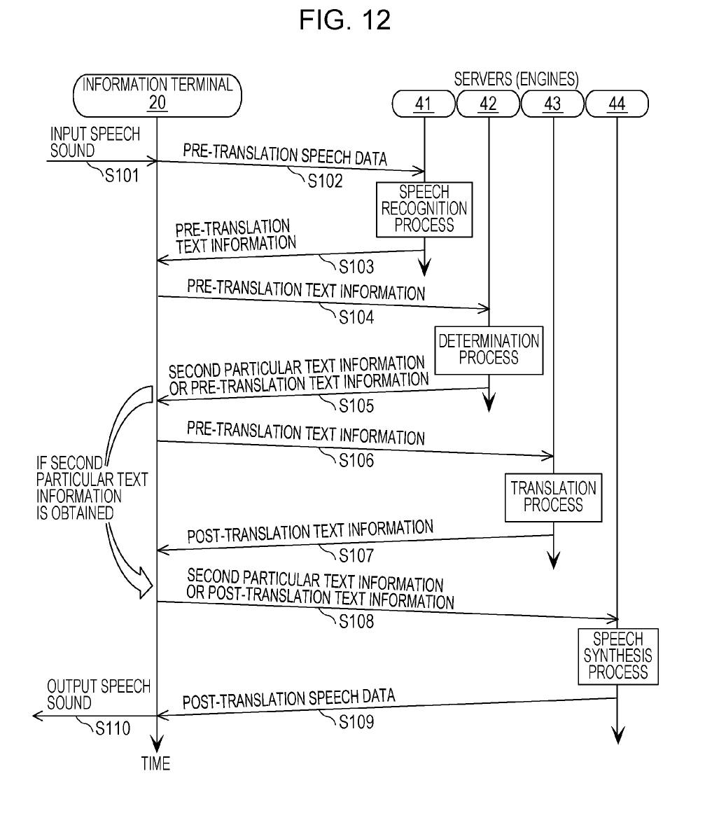

Next, the operation of the machine translation system 10B configured as above will be described. Transmission of data between the information terminal 20 and the servers 41 to 44 will be described hereinafter with reference to FIG. 12.

FIG. 12 is a sequence diagram illustrating an example of the operation of the machine translation system 10B according to the modification of the first embodiment.

As illustrated in FIG. 12, first, the information terminal 20 receives a speech sound uttered by a speaker in the first language (S101) and transmits pre-translation speech data, which is obtained by converting the speech sound, to the server 41 through the communication means 30 (S102).

Next, the server 41 performs the speech recognition process on the received pre-translation speech data to convert the pre-translation speech data into pre-translation text information in the first language. The server 41 then transmits the pre-translation text information to the information terminal 20 (S103).

Next, the information terminal 20 transmits the pre-translation text information received from the server 41 to the server 42 (S104). The server 42 performs the determination process and, if determining that the pre-translation text information received from the information terminal 20 includes the first particular text information, transmits the second particular text information associated with the first particular text information to the information terminal 20 (S105). If determining that the pre-translation text information received from the information terminal 20 does not include the first particular text information, the server 42 transmits the pre-translation text information to the information terminal 20 (S105). Alternatively, the server 42 may transmit, to the information terminal 20, only information indicating that the pre-translation text information does not include the first particular text information.

Next, if the information terminal 20 receives the pre-translation text information or the information indicating that the pre-translation text information does not include the first particular text information from the server 42, the information terminal 20 transmits the pre-translation text information to the server 43 (S106). The server 43 performs the translation process to generate post-translation text information in the second language from the pre-translation text information received from the information terminal 20. The server 43 then transmits the generated post-translation text information to the information terminal 20 (S107).

Next, the information terminal 20 receives the post-translation text information from the server 43 and transmits the post-translation text information to the server 44 (S108).

On the other hand, if receiving the second particular text information from the server 42 in S105, the information terminal 20 transmits the second particular text information to the server 44 while skipping the translation process (S108).

Next, the server 44 performs the speech synthesis process to generate post-translation speech data regarding the second particular text information or the post-translation text information. The server 44 then transmits the generated post-translation speech data regarding the second particular text information or the post-translation text information to the information terminal 20 (S109).

Lastly, the information terminal 20 outputs a speech sound indicating the post-translation speech data regarding the second particular text information or the post-translation text information received from the server 43 (S110).

### Advantageous Effects

As described above, according to the present modification, a speaker (utterer) can cause the machine translation system 10B to output a frequently used fixed text in the second language (second particular text information) unique to each scene, such as a word or a sentence, just by speaking a particular word or sentence (first particular text information) to the machine translation system 10B in the first language. As a result, the burden on the speaker is reduced.

Although the storage section 163 included in the server 42 stores the second particular text information associated with the first particular text information, the storage section 163 need not store the second particular text information. The storage section 163 may store post-translation speech data regarding the second particular text information associated with the first particular text information, instead. Transmission of data between the information terminal 20 and the servers 41 to 44 in this case will be described hereinafter.

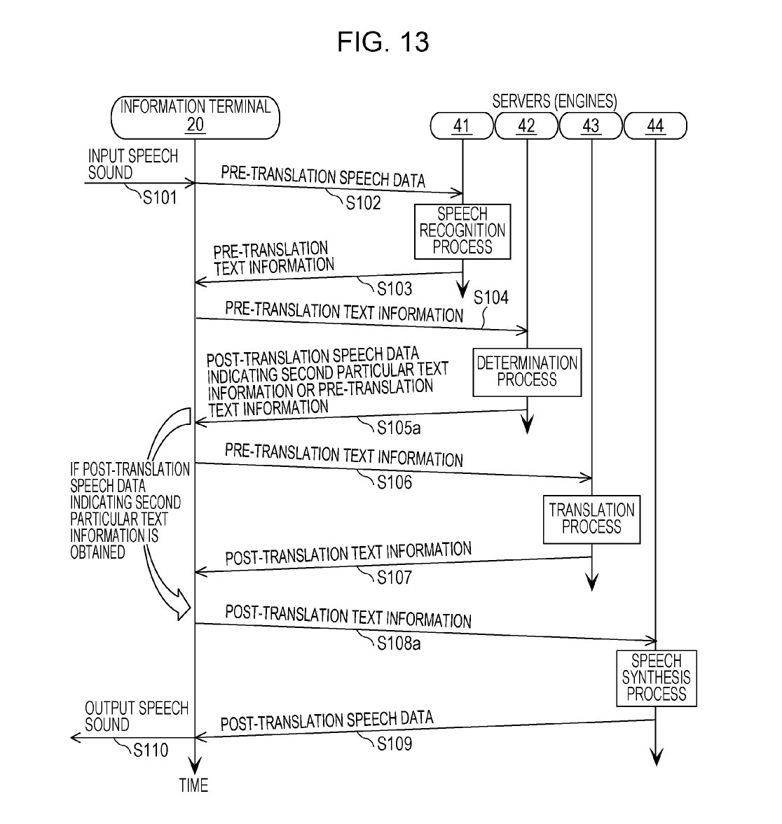

FIG. 13 is a sequence diagram illustrating another example of the machine translation system 10B according to the modification of the first embodiment. The same steps as those illustrated in FIG. 12 are given the same reference numerals, and detailed description thereof is omitted. The sequence diagram of FIG. 13 is different from the sequence diagram of FIG. 12 in that the sequence diagram of FIG. 13 includes S105a and S108a, which will be described hereinafter.

In S105a, the server 42 performs the determination process and, if determining that the pre-translation text information received from the information terminal 20 includes the first particular text information, transmits, to the information terminal 20, the post-translation speech data regarding the second particular text information associated with the first particular text information.

If the information terminal 20 has received the post-translation speech data regarding the second particular text information from the server 42, the information terminal 20 does not transmit anything to the server 44 in S108a, that is, the information terminal 20 skips the speech synthesis process.

In S110, therefore, the information terminal 20 outputs a speech sound indicating the post-translation speech data regarding the second particular text information received from the server 42.

### Second Embodiment

Although the machine translation system 10 according to the first embodiment performs the process for determining whether the pre-translation text information includes the first particular text information stored in the storage section 163, such a process need not be performed. A process for determining whether the pre-translation text information and the first particular text information stored in the storage section 163 perfectly match may be performed, instead. This case will be referred to as a second embodiment, and differences from the first embodiment will be mainly described hereinafter.

### Configuration of Machine Translation System 10

A machine translation system 10 according to the second embodiment is different from the machine translation system 10 according to the first embodiment in terms of the translation determination processing unit 16. The other components of the machine translation system 10 according to the second embodiment are the same as those of the machine translation system 10 according to the first embodiment, and description thereof is omitted.

### Translation Determination Processing Unit 16

A translation determination processing unit 16 according to the second embodiment is different from the translation determination processing unit 16 according to the first embodiment in terms of the operation of the determination section 162. The other components of the translation determination processing unit 16 according to the second embodiment are the same as those of the translation determination processing unit 16 according to the first embodiment, and description thereof is omitted.

In the present embodiment, the determination section 162 determines whether the pre-translation text information obtained by the obtaining section 161 and the first particular text information stored in the storage section 163 match. If determining that the pre-translation text information and the first particular text information match, the determination section 162 causes the output section 164 to output the second particular text information associated with the first particular text information in the storage section 163. The other steps are as described in the first embodiment, and description thereof is omitted.

### Operation of Machine Translation System 10

A specific example of the operation of the machine translation system 10 according to the second embodiment configured as above will be described.

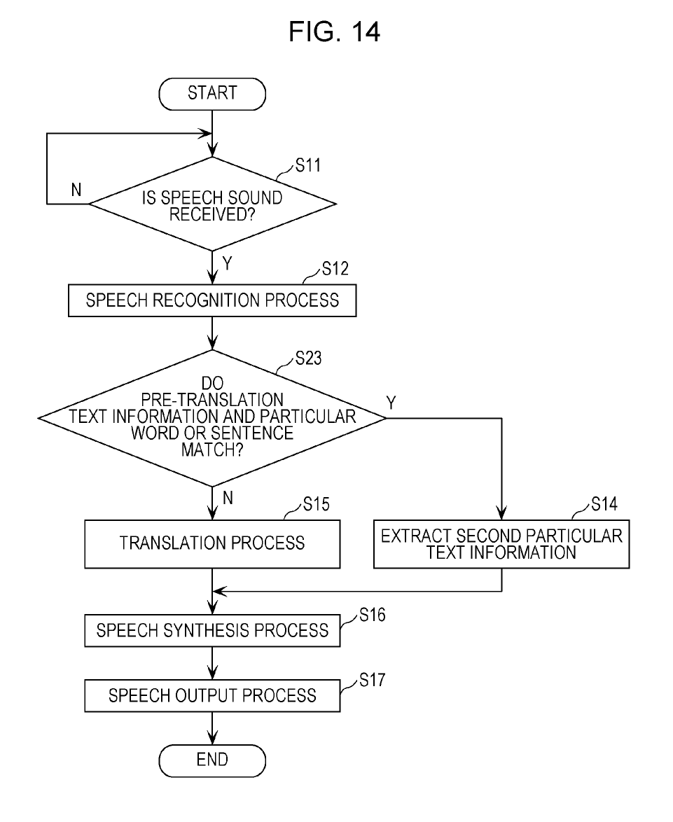

FIG. 14 is a flowchart illustrating a specific example of the operation of the machine translation system 10 according to the second embodiment. The same steps as those illustrated in FIG. 7 are given the same reference numerals, and detailed description thereof is omitted. That is, the processing in S11, S12, and S14 to S17 illustrated in FIG. 14 are as described in the first embodiment, and description thereof is omitted. A determination process, which is different from that in the first embodiment, including S23 will be described hereinafter.

In S23, the translation determination processing unit 16 performs the determination process. That is, the translation determination processing unit 16 determines whether the obtained pre-translation text information and a particular word or sentence registered to the storage section 163 in advance match (S23). If the pre-translation text information and a particular word or sentence registered to the storage section 163 in advance match in S23 (Y in S23), the translation determination processing unit 16 extracts the second particular text information associated with the first particular text information in the storage section 163 (S14).

This process will be described more specifically with reference to FIG. 8.

It is assumed, for example, that a speaker says, “I will explain the translation device”, to the machine translation system 10 according to the second embodiment in Japanese. As illustrated in FIG. 8, the storage section 163 stores the particular sentence “explain the translation device” as the first particular text information, but the speech sound uttered by the speaker includes not only “explain the translation device” but also “I will”. In this case, the machine translation system 10 according to the second embodiment determines in S23 that the speech sound uttered by the speaker and the first particular text information do not perfectly match (N in S23), and the process proceeds to S15. In S15, the machine translation system 10 according to the second embodiment performs the translation process and outputs post-translation text information in the second language, namely “I will explain the translation device” in English, to the speech synthesis unit 14.

On the other hand, it is assumed that the speaker says, “explain the translation device”, to the machine translation system 10 according to the second embodiment in Japanese. As illustrated in FIG. 8, the storage section 163 stores the particular sentence “explain the translation device” as the first particular text information. In this case, the machine translation system 10 according to the second embodiment determines in S23 that the speech sound uttered by the speaker and the first particular text information perfectly match (Y in S23), and the process proceeds to S14.

### Advantageous Effects

As described above, if the pre-translation text information and the first particular text information match, the machine translation system 10 according to the second embodiment outputs the second particular text information. That is, if a speaker (utterer) speaks only the first particular text information, the machine translation system 10 outputs the second particular text information as a translation result. If the speaker (utterer) speaks a sentence including a word other than the first particular text information, the machine translation system 10 outputs a translation of the sentence.

As a result, a speaker who uses the machine translation system 10 can include a particular word or sentence indicated by the first particular text information in a sentence.

In other words, it is assumed that a speaker desires to use a frequently used fixed text registered in advance and associated with a particular sentence such as “explain the translation device” for another person (listener). In this case, the speaker can cause the machine translation system 10 to output the fixed sentence (second particular text information) by speaking only the registered particular sentence (first particular text information).

On the other hand, the speaker might desire to talk to the listener using an expression different from a fixed text (second particular text information) registered in advance when, for example, the listener did not understand the fixed sentence. At this time, if the machine translation system 10 determines that a speech sound (pre-translation text information) uttered by the speaker includes a registered particular sentence (first particular text information) such as “explain the translation device” and outputs a fixed text corresponding to the particular sentence (first particular text information), the speaker undesirably needs to avoid including the first particular text information in a speech sound uttered thereby. In the second embodiment, however, a determination as to whether the pre-translation text information and the first particular text information match is made. As a result, the speaker can freely speak a sentence including a registered particular sentence (first particular text information) such as “explain the translation device” to cause the machine translation system 10 to perform the translation process. The speaker can thus flexibly determine whether to cause the machine translation system 10 to output a fixed text for the listener or explain in his/her own words.

If the speaker is to explain a translation device but the listener has used the translation device in the past, for example, the speaker might desire to say, “Would you like me to explain the translation device?”, to the listener. If the machine translation system 10 determines that the speech sound uttered by the speaker includes a registered particular sentence such as “explain the translation device” and outputs a fixed text corresponding to the particular sentence, the speaker undesirably cannot speak the above sentence. In the present embodiment, however, the machine translation system 10 outputs a translation of the sentence, “Would you like me to explain the translation device?”, in the second language to receive a response from the listener. As a result, with the machine translation system 10 according to the present embodiment, the speaker can determine whether to explain the translation device through a natural conversation and, if the listener does not want the speaker to explain the translation device, prevent the machine translation system 10 from outputting a fixed text explaining the translation device.

Furthermore, with the machine translation system 10 according to the present embodiment, the second particular text information is output only if the pre-translation text information and a particular word or sentence, which is the first particular text information, perfectly match. The speaker, therefore, need not take care not to speak a sentence including a particular word or sentence in usual conversations.

The machine translation system 10 may also include a display as in the first embodiment and the like. In this case, when performing the determination process and outputting an English fixed text associated with a particular sentence in the storage section 163 for a listener whose mother tongue is English, the machine translation system 10 displays a translated fixed text (third particular text information) corresponding to the fixed text on the display for a speaker whose mother tongue is Japanese. As a result, when a speech sound indicating a fixed text in the second language (second particular text information) different from but associated with a particular sentence uttered by a speaker in the first language is output, the speaker can understand what kind of fixed text is being output as a speech sound. In addition, even if the speaker has not learned fixed texts by heart, the speaker can understand what kind of fixed text is being output in the second language as a speech sound by taking a look at a translated fixed text (fixed text in the first language). The speaker, therefore, can smoothly talk with another person.

### Modification

Although the first and second embodiments have been described as different embodiments above, the first and second embodiments may be combined with each other. An example of this case will be described with reference to FIG. 8.

FIG. 8 illustrates a “type” column. If the “type” column indicates “1” for a particular sentence and a speech sound (pre-translation text information) uttered by a speaker includes the particular sentence (first particular text information), for example, the machine translation system 10 may be caused to output a fixed text (second particular text information) corresponding to the particular sentence. On the other hand, if the “type” column indicates “2” for a particular sentence, the machine translation system 10 may be caused to output a fixed text (second particular text information) corresponding to the particular sentence only if a speech sound (pre-translation text information) uttered by a speaker and the particular text (first particular text information) perfectly match.

As a result, the determination process can be performed such that a rarely used particular sentence is converted into the second particular text information registered in advance when the particular sentence is included in a speech sound uttered by a speaker, and a frequently used particular sentence is converted into the second particular text information registered in advance only when a speech sound uttered by a speaker and the particular sentence perfectly match. That is, the determination process can be performed while applying an individual rule to each particular sentence. This means that a convenient rule can be applied to each registered particular word or sentence in accordance with the frequency at which the particular word or sentence is used. That is, the machine translation system 10 becomes more convenient to the speaker (user).

### Third Embodiment

In a third embodiment, an example of a determination process different from those described in the first and second embodiments will be described.

### Configuration of Machine Translation System 10

A machine translation system 10 according to the third embodiment is different from the machine translation system 10 according to the first embodiment in terms of the translation determination processing unit 16. The other components of the machine translation system 10 according to the third embodiment are the same as those of the machine translation system 10 according to the first embodiment, and description thereof is omitted.

### Translation Determination Processing Unit 16

A translation determination processing unit 16 according to the third embodiment is different from the translation determination processing unit 16 according to the first embodiment in terms of what is stored in the storage section 163 and the operation of the determination section 162. The other components of the translation determination processing unit 16 according to the third embodiment are the same as those of the translation determination processing unit 16 according to the first embodiment, and description thereof is omitted.

In the present embodiment, the storage section 163 stores the first particular text information, which indicates a particular word or sentence in the first language, and the second particular text information, which indicates a prepared fixed text such as a word or a sentence in the second language, which is different from the first language, and which does not have translation equivalence with the particular word or sentence, associated with each other.

The storage section 163 also stores, for each piece of the second particular text information, two or more pieces of first particular text information and order information, which indicates order in which the two or more pieces of first particular text information should appear in a sentence.

The determination section 162 determines whether the pre-translation text information includes the two or more pieces of first particular text information stored in the storage section 163 and the two or more pieces of first particular text information appear in the order indicated by the order information.

It is assumed that the determination section 162 has determined that the pre-translation text information includes the two or more pieces of first particular text information stored in the storage section 163 and the two or more pieces of first particular text information appear in the order indicated by the order information. In this case, the determination section 162 causes the output section 164 to output the second particular information associated with the two or more pieces of first particular text information and the order information.

The other steps are as described in the first embodiment, and description thereof is omitted.

As described above, the translation determination processing unit 16 according to the third embodiment determines whether a speech sound (pre-translation text information) uttered by a speaker includes particular words or sentences (first particular text information) registered in advance in order of utterance registered in advance. If the speech sound uttered by the speaker includes the particular words or sentences in the order of utterance registered in advance, the translation process is not performed, and a fixed text (second particular text information) registered in advance corresponding to the particular words or sentences is output.

### Operation of Machine Translation System 10

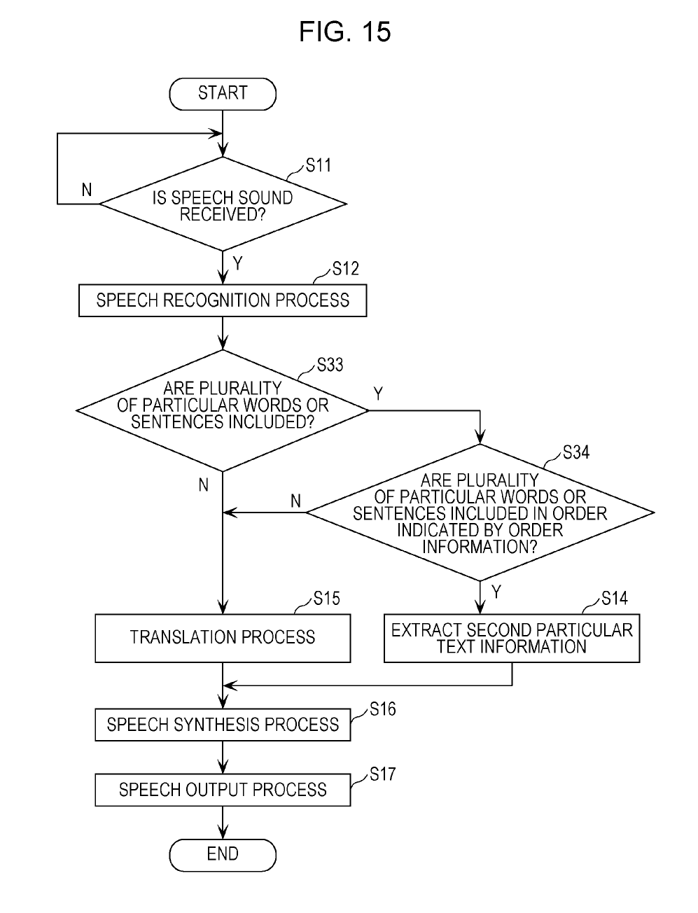

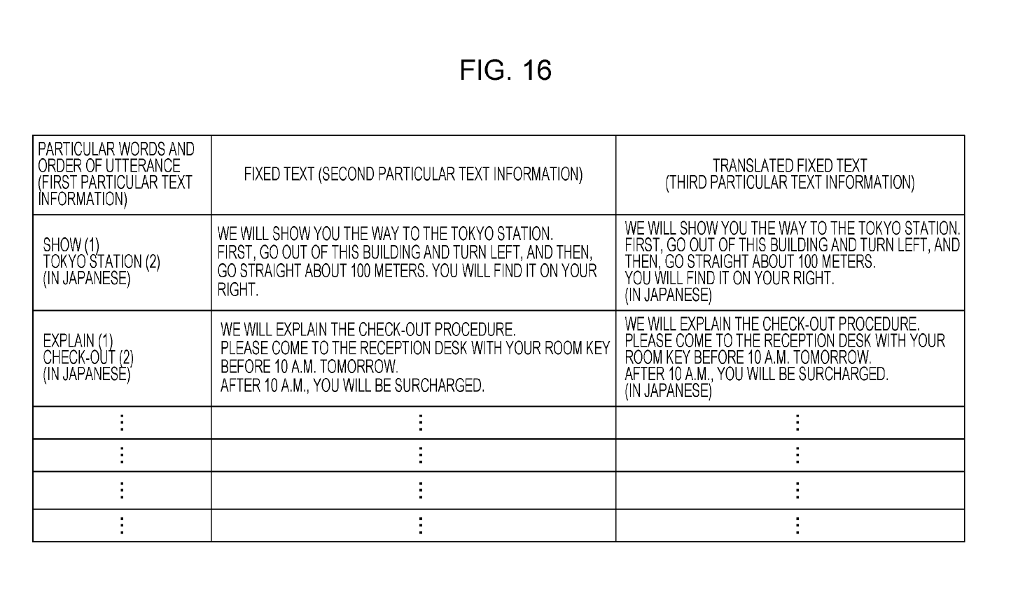

A specific example of the operation of the machine translation system 10 according to the third embodiment configured as above will be described with reference to FIGS. 15 and 16.

FIG. 15 is a flowchart illustrating a specific example of the operation of the machine translation system 10 according to the third embodiment. The same steps as those illustrated in FIG. 7 are given the same reference numerals, and detailed description thereof is omitted. That is, the processing in S11, S12, and S14 to S17 illustrated in FIG. 15 are as described in the first embodiment, and a determination process, which is different from that in the first embodiment, including S33 and S34 will be described hereinafter.

In S33 and S34, the translation determination processing unit 16 performs the determination process. That is, the translation determination processing unit 16 determines whether the obtained pre-translation text information includes particular words or sentences registered to the storage section 163 in advance (S33).

If the pre-translation text information includes the particular words or sentences in S33 (Y in S33), the translation determination processing unit 16 determines whether the particular words or sentences appear in order indicated by order information registered to the storage section 163 in advance (S34). That is, in S34, the translation determination processing unit 16 identifies order in which the particular words or sentences appear in the pre-translation text information. More specifically, in S34, the translation determination processing unit 16 determines whether the order in which the particular words or sentences appear and the order indicated by the order information stored in the storage section 163 match.

If determining in S34 that the particular words or sentences appear in the order indicated by the order information (Y in S34), the translation determination processing unit 16 extracts the second particular text information associated with the particular words or sentences in the storage section 163 (S14). If the translation determination processing unit 16 determines in S33 that the pre-translation text information does not include the particular words or sentences, or if the translation determination processing unit 16 determines in S34 that the particular words or sentences do not appear in the pre-translation text information in the order indicated by the order information, the process proceeds to S15.

FIG. 16 is a diagram illustrating an example of fixed texts associated with particular words and order of utterance in the storage section 163 according to the third embodiment.

FIG. 16 illustrates Japanese particular words as an example of the first particular text information and order of utterance as an example of the order information indicating order in which the particular words should appear in a sentence. FIG. 16 also illustrates English fixed texts as an example of the second particular text information. FIG. 16 also illustrates translated fixed texts, which are Japanese translations of the English fixed texts, as an example of the third particular text information.

More specifically, FIG. 16 indicates that a particular word “show” is associated with order information “(1)”, and a particular word “Tokyo Station” is associated with order information “(2)” in the storage section 163.

If a speaker says, “Show, Tokyo Station”, to the machine translation system 10 in Japanese, for example, the machine translation system 10 converts speech data regarding the speech sound uttered by the speaker into Japanese pre-translation text information through the speech recognition process. Next, the translation determination processing unit 16 of the machine translation system 10 performs the determination process to determine that the pre-translation text information includes the particular words “show” and “Tokyo Station” stored in the storage section 163. Furthermore, the machine translation system 10 determines whether the particular words appear in the pre-translation text information in the order indicated by the order information associated with the particular words. That is, in the storage section 163, the order indicated by the order information associated with the particular word “show” is “(1)”, and the order indicated by the order information associated with the particular word “Tokyo Station” is “(2)”. The machine translation system 10 then determines that the particular words “show” and “Tokyo Station” appear in the pre-translation text information in this order. That is, the machine translation system 10 determines that the order indicated by the order information and the identified order match. The machine translation system 10 then extracts a fixed text (second particular text information) corresponding to the particular words “show” and “Tokyo Station” (first particular text information), namely “We will show you the way to the Tokyo Station. First, go out of this building and turn left, and then, go straight about 100 meters. You will find it on your right”, and performs the speech synthesis process and the speech output process to output a speech sound indicating the English fixed text.

On the other hand, it is assumed that a speaker says, “Shall I show you the way to the Tokyo Station?”, to the machine translation system 10 in Japanese in order to ask a listener whether the listener wants the speaker to show the way to the Tokyo Station. In this case, the machine translation system 10 converts speech data regarding the speech sound uttered by the speaker into Japanese pre-translation text information through the speech recognition process. Next, the translation determination processing unit 16 of the machine translation system 10 performs the determination process to determine that the pre-translation text information includes the particular words “show” and “Tokyo Station” stored in the storage section 163. Furthermore, the machine translation system 10 determines whether the particular words appear in the pre-translation text information in the order indicated by the order information associated with the particular words. That is, the order indicated by the order information associated with the particular word “show” is “(1)”, and the order indicated by the order information associated with the particular word “Tokyo Station” is “(2)” in the storage section 163. The machine translation system 10 then determines that the particular words “Tokyo Station” and “show” appear in the pre-translation text information in this order (Note: In Japanese, “Tokyo Station” appears earlier than “show” in this case for grammatical reasons. It is actually more like “To the Tokyo Station, show you the way, shall I?”). That is, the machine translation system 10 determines that the order indicated by the order information and the identified order do not match. The machine translation system 10 performs the translation process to translate the Japanese sentence, “Shall I show you the way to the Tokyo Station?”, uttered by the speaker into English and then performs the speech synthesis process and the speech output process to output a speech sound indicating a resultant English sentence.

The same holds for a case in which a speaker speaks particular words “explain” and “check-out”, and description thereof is omitted.

As in the first embodiment and the like, the machine translation system 10 may also include a display. In this case, when performing the determination process and outputting an English fixed text associated with particular words in the storage section 163 for a listener whose mother tongue is English, the machine translation system 10 displays a translated fixed text (third particular text information) corresponding to the fixed text on the display for a speaker whose mother tongue is Japanese. As a result, when a speech sound indicating a fixed text in the second language (second particular text information) different from but associated with a particular sentence uttered by a speaker in the first language is output, the speaker can understand what kind of fixed text is being output as a speech sound. In addition, even if the speaker has not learned fixed texts by heart, the speaker can understand what kind of fixed text is being output in the second language as a speech sound by taking a look at a translated fixed text (fixed text in the first language). The speaker, therefore, can smoothly talk with another person.

### Advantageous Effects

As described above, according to the third embodiment, a speaker (utterer) can easily determine whether to use the second particular text information, which is a frequently used fixed text registered in advance, by speaking, or not speaking, particular words or sentences in certain order.

In addition, as illustrated in FIG. 16, if the first language is Japanese, order information “(1)” may be set to a particular word indicating a verb, and order information “(2)” may be set to a particular word indicating a subject or an object, because, in Japanese, a verb usually appears near an end of a sentence. In this case, even if a speech sound unintendedly includes particular words, the second particular text information is not output. In addition, a speaker can determine whether to cause the machine translation system 10 to output the second particular text information or a translation of a speech sound uttered thereby by changing the order in which the first particular text information appears in the speech sound uttered thereby.

That is, with the machine translation system 10 according to the third embodiment, the second particular text information can be easily output without affecting the translation process performed for other ordinary conversations by intentionally speaking a sentence in unusual order. In addition, with the machine translation system 10 according to the third embodiment, a speaker who does not know output conditions of the second particular text information stored in the storage section 163 does not unintendedly cause the machine translation system 10 to output the second particular text information unless the speaker talks in unusual order.

Pairs of a verb and another part of speech may be registered to the storage section 163 as particular words. For example, the particular word “show” is set as a verb, and “(1)” is associated with the particular word as order information. A plurality of particular words that are other parts of speech are then associated with the particular word “show”, namely, for example, “Osaka Station”, “Tokyo Skytree”, and “toilet”. The order information “(2)” may be associated with the particular words that are other parts of speech. By storing pairs of particular words in the storage section 163 in a 1-to-n manner, the second particular text information can be mechanically added, and the storage section 163 can be easily maintained, that is, information can be easily added to the storage section 163, the storage section 163 can be easily updated, and redundant entries can be easily avoided.

The machine translation method and the machine translation system according to one or a plurality of aspects of the present disclosure have been described on the basis of the above embodiments, but the present disclosure is not limited to the above embodiments. Modes obtained by modifying the above embodiments in various ways conceived by those skilled in the art and modes constructed by combining components in different embodiments are also included in the scope of the one or plurality of the present disclosure, insofar as the spirit of the present disclosure is not deviated from.

In the machine translation method and the machine translation system in the present disclosure, for example, the speech recognition process, the translation determination process, and the translation process may be performed by different independent servers as illustrated in FIG. 10. Parts of these processes may be performed by the same server, or all the processes may be performed by the same server, instead. In any case, the same advantageous effects are produced.

These processes need not necessarily be performed by servers through communication means such as a network. A part of these processes may be performed by an information terminal connected through an internal bus, that is, using a function of the information terminal, instead. Alternatively, a part of these process may be performed by a peripheral device directly connected to the information terminal.

As described above, in the machine translation method and the machine translation system in the present disclosure, when a speech sound is translated into another language, not only a speech sound is output in the other language but also a text may be displayed on a display in the other language. The same advantageous effects are produced.

The techniques described in the above embodiments can be achieved by the following types of cloud service. The types of cloud service that can achieve the techniques described in the above embodiments are not limited to these.

### First Service Type: Data Center Cloud Service

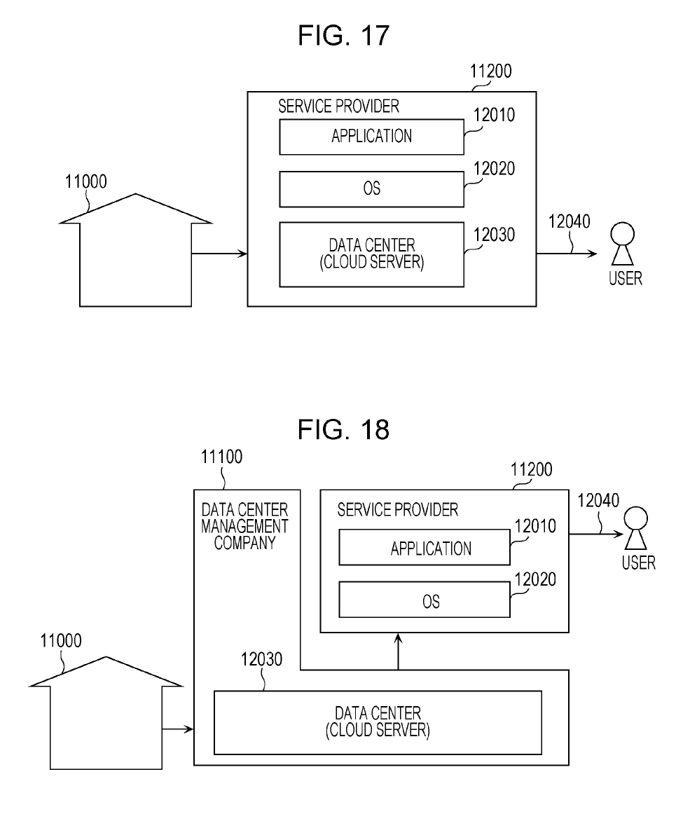

FIG. 17 is a diagram illustrating an outline of a service provided by an information management system according to a first service type (data center cloud service). In the first service type, the service provider 11200 obtains information from the group 11000 and provides the service for a user. In the first service type, the service provider 11200 has functions of data center management company. That is, the service provider 11200 owns the cloud server 11110 that manages big data. The information management system, therefore, does not include a data center management company.

In the first service type, the service provider 11200 manages a data center (cloud server) 12030. The service provider 11200 also manages an operating system (OS) 12020 and an application 12010. The service provider 11200 provides the service using the OS 12020 and the application 12010 managed by the service provider 11200 (arrow 12040).

### Second Service Type: IaaS Cloud Service

FIG. 18 is a diagram illustrating an outline of a service provided by an information management system according to a second service type (Infrastructure as a System (IaaS) cloud service). In the IaaS cloud service, an infrastructure itself for constructing and operating a computer system is provided as a service through the Internet.

In the second service type, the data center management company 11100 manages the data center (cloud server) 12030. The service provider 11200 also manages the OS 12020 and the application 12010. The service provider 11200 provides the service using the OS 12020 and the application 12010 managed by the service provider 11200 (arrow 12040).

### Third Service Type: PaaS Cloud Service

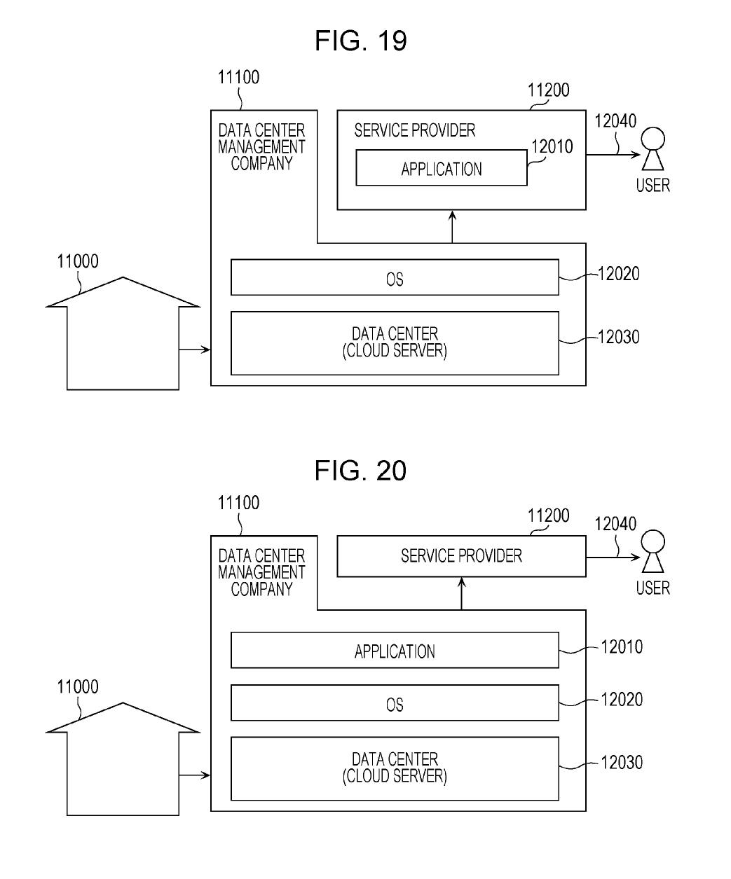

FIG. 19 is a diagram illustrating an outline of a service provided by an information management system according to a third service type (Platform as a Service (PaaS) cloud service). In the PaaS cloud service, a platform for constructing and operating software is provided as a service through the Internet.

In the third service type, the data center management company 11100 manages the OS 12020 and the data center (cloud server) 12030. The service provider 11200 manages the application 12010. The service provider 11200 provides the service using the OS 12020 managed by the data center management company 11100 and the application 12010 managed by the service provider 11200 (arrow 12040).

### Fourth Service Type: SaaS Cloud Service

FIG. 20 is a diagram illustrating an outline of a service provided by an information management system according to a fourth service type (Software as a Service (SaaS) cloud service). In the SaaS cloud service, for example, a user such as a company or an individual who does not own a data center (cloud server) can use an application provided by a platform provider who owns a data center (cloud server) through a network such as the Internet.

In the fourth service type, the data center management company 11100 manages the application 12010, the OS 12020, and the data center (cloud server) 12030. The service provider 11200 provides the service using the OS 12020 and the application 12010 managed by the data center management company 11100 (arrow 12040).

In any of the above types of cloud service, the service provider 11200 provides a service. A service provider or a data center management company may develop an OS, an application, a database of big data, or the like or may outsource development work.

The present disclosure can be applied to a machine translation method and a machine translation system and particularly to a readily available machine translation system, such as a PC application, a web application, or a smartphone application, and a machine translation method used in the machine translation system.

What is claimed is:

1. A machine translation method used in a machine translation system, the machine translation method comprising:
obtaining pre-translation text information generated by converting first speech data indicating an input speech sound uttered in a first language into text information;
determining whether the pre-translation text information includes first particular text information, which indicates a particular word or sentence in the first language stored in a memory of the machine translation system, the memory storing the first particular text information and at least either second particular text information, which indicates a prepared fixed text that is a word or a sentence in the second language, which is different from the first language, and which does not have translation equivalence with the particular word or sentence, or second speech data regarding the second particular text information associated with the first particular text information; and
outputting, if it is determined that the pre-translation text information includes the first particular text information, at least either the second particular text information or the second speech data regarding the second particular text information associated with the first particular text information in the memory.

2. The machine translation method according to claim 1,
wherein, in the determining, it is determined whether the pre-translation text information and the first particular text information stored in the memory match, and
wherein, if it is determined that the pre-translation text information and the first particular text information match, at least either the second particular information or the second speech data regarding the second particular text information associated with the first particular text information in the memory is output in the outputting.

3. The machine translation method according to claim 1,
wherein, in the memory, a piece of the second particular text information is associated with two or more pieces of the first particular text information and order information indicating order in which the two or more pieces of the first particular text information should appear in a sentence,
wherein, in the determining, it is determined whether the pre-translation text information includes the two or more pieces of the first particular text information stored in the memory and whether the two or more pieces of the first particular text information appear in the order indicated by the order information, and
wherein, if it is determined that the pre-translation text information includes the two or more pieces of the first particular text information stored in the memory and that the two or more pieces of the first particular text information appear in the order indicated by the order information, at least either the piece of the second particular text information or the second speech data regarding the piece of the second particular text information associated with the two or more pieces of the first particular text information and the order information is output in the outputting.

4. The machine translation method according to claim 1,
wherein, in the memory, a piece of the second particular text information is associated with one or more different pieces of the first particular text information indicating different particular sentences including a same particular word.

5. The machine translation method according to claim 1,
wherein, if it is determined that the pre-translation text information does not include the first particular text information, translated text information, which is a translation of the pre-translation text information into the second language, is output in the outputting.

6. The machine translation method according to claim 5,
wherein, if it is determined that the pre-translation text information includes the first particular text information stored in the memory, the translated text information is not output in the outputting.

7. The machine translation method according to claim 1,
wherein, in the memory, third particular text information, which is a translation of the second particular text information into the first language, is associated with the first particular text information and the second particular text information, or at least with the second particular text information,
wherein, if at least either the second particular text information or the second speech data regarding the second particular text information is output in the outputting, the third particular text information is also output.

8. The machine translation method according to claim 7,
wherein the third particular text information output in the outputting is displayed on a display.

9. The machine translation method according to claim 1,
wherein the machine translation system is connected, through a certain communicator, to an information terminal including a display, and
wherein, in the outputting, at least either the second particular text information or the second speech data regarding the second particular text information is output to the information terminal through the certain communicator.

10. The machine translation method according to claim 9,
wherein, if the second particular text information is output in the outputting, the information terminal generates the second speech data by performing a speech synthesis process on the second particular text information and outputs a speech sound indicating the generated second speech data.

11. The machine translation method according to claim 1,
wherein the machine translation method is used in a certain situation between a speaker of the first language and a speaker of the second language.

12. A machine translation system comprising:
a storage that stores first particular text information, which indicates a particular word or sentence in a first language and at least either second particular text information, which indicates a prepared fixed text that is a word or a sentence in a second language, which is different from the first language, and which does not have translation equivalence with the particular word or sentence, or second speech data regarding the second particular text information associated with the first particular text information;
a processor; and
a memory storing a computer program for causing the processor to perform operations including:
obtaining pre-translation text information generated by converting first speech data indicating an input speech sound uttered in the first language into text information,
determining whether the pre-translation text information includes the first particular text information stored in the storage, and
outputting, if the pre-translation text information includes the first particular text information, at least either the second particular text information or the second speech data regarding the second particular text information associated with the first particular text information in the storage.
